(19) United States
(12) Patent Application Publication
(10) Pub. No.: US 2019/0188926 A1
(43) Pub. Date: Jun. 20, 2019

(54) SERVICE MANAGEMENT SYSTEM, NON-TRANSITORY COMPUTER-READABLE MEDIUM STORING SERVICE MANAGEMENT PROGRAM, AND SERVICE MANAGEMENT METHOD

(71) Applicant: TOYOTA JIDOSHA KABUSHIKI KAISHA, Toyota-shi (JP)

(72) Inventor: Akimichi UMIGAI, Nagoya-shi (JP)

(73) Assignee: TOYOTA JIDOSHA KABUSHIKI KAISHA, Toyota-shi (JP)

(21) Appl. No.: 16/212,747

(22) Filed: Dec. 7, 2018

(30) Foreign Application Priority Data
Dec. 20, 2017 (JP) 2017-243640

(51) Int. Cl. G07C 5/08; G06F 3/06; G07C 5/02; G07C 5/00

(52) U.S. Cl. CPC G07C 5/085; G06F 3/0604; G07C 5/008; G06F 3/0673; G07C 5/02; G06F 3/0647

(57) ABSTRACT

A service management system includes a storage unit and a service management unit. The storage unit stores service information associated with a vehicle ID assigned to each vehicle and a user ID assigned to each user of the vehicle. The service information includes content of a service to be provided to the user of the vehicle. The service management unit reads from the storage unit the service information associated with both the vehicle ID assigned to the vehicle and the user ID assigned to the user and manages the content of the service to be provided to the user of the vehicle when the user of the vehicle uses the service.

### INCORPORATION BY REFERENCE

The disclosure of Japanese Patent Application No. 2017-243640 filed on Dec. 20, 2017 including the specification, drawings and abstract is incorporated herein by reference in its entirety.

### BACKGROUND

### 1. Technical Field

The disclosure relates to a service management system, a non-transitory computer-readable medium storing a service management program, and a service management method.

### 2. Description of Related Art

Japanese Patent Application Publication No. 2006-4180 (JP 2006-4180 A) describes a system, in which a shop terminal is connected to a vehicle and user terminals so that they can communicate with each other, and communications with the vehicle and the user terminals are authenticated based on personal authentication information registered to the shop terminal. In this system, a vehicle ID, a personal ID, and a user terminal ID are associated with each other in a customer data base server managed by the shop terminal. The shop terminal uses the vehicle information such as a use history and repair history of the vehicle to provide a service for the vehicle such as notification of periodical check for oil change to the user terminal corresponding to the user terminal ID associated with the vehicle ID. The shop terminal uses personal information such as gender, age, and accident-free record to provide a service for the individual to the user terminal corresponding to the user terminal ID associated with the personal ID.

### SUMMARY

In the system described in JP 2006-4180 A, although content of services to be provided to the vehicle user is determined based on user characteristics extracted from the personal information, the content of the services to be provided is not managed for individual users. Thus, there has been room for improvement in providing services suitable for each user.

The disclosure provides a service management system, a non-transitory computer-readable medium storing a service management program, and a service management method in view of the above circumstances.

A first aspect of the disclosure relates to a service management system. The service management system includes a storage unit that stores service information associated with a vehicle ID assigned to each vehicle and a user ID assigned to each user of the vehicle, the service information including content of a service to be provided to the user of the vehicle. The service management system also includes a service management unit configured to read from the storage unit the service information associated with both the vehicle ID assigned to the vehicle and the user ID assigned to the user and manage the content of the service to be provided to the user of the vehicle when the user of the vehicle uses the service.

A second aspect of the disclosure relates to a non-transitory computer-readable medium storing a service management program. The program causes a computer, which includes a storage unit in which service information including content of a service to be provided to a user of a vehicle, a vehicle ID assigned to each vehicle, and a user ID assigned to each user of the vehicle are associated with each other, to execute a process, when the user of the vehicle uses the service. The process includes reading from the storage unit the service information associated with both the vehicle ID and the user ID and managing the content of the service to be provided to the user of the vehicle.

A third aspect of the disclosure relates to a service management method for managing service information including content of a service to be provided to a user of a vehicle. The service management method includes associating a vehicle ID assigned to each vehicle with service information and associating a user ID assigned to each user of a vehicle with the service information, and managing the content of the service by providing the user of the vehicle with the service information associated with both the vehicle ID assigned to the vehicle and the user ID assigned to the user when the user of the vehicle uses the service.

According to the above aspects, when the user of the vehicle uses the service, the content of the service to be provided to the user of the vehicle varies based on the service information associated with both the vehicle ID and the user ID, the service information being different depending on the combination of the user and the vehicle. Thus, it is possible to manage the service to be provided to the user of the vehicle.

In the above service management system, the service information may include a free service and a paid service.

With the above configuration, it is possible to expand the content of the service to be provided to the user of the vehicle.

In the above service management system, the service information may include a period of validity of the service and contractor information of the service.

With the above configuration, it is possible to manage the content of the service to be provided to the user of the vehicle in accordance with the content of contract of the service.

In the above service management system, the service information may include information on a supervisor of the vehicle.

With the above configuration, it is possible to manage the content of the service to be provided to the user of the vehicle depending on whether the user of the vehicle is the supervisor of the vehicle.

In the above service management system, the service to be provided to the user of the vehicle may include a service available both through on-board equipment installed in the vehicle and through communication equipment that communicates with the vehicle.

With the above configuration, it is possible to provide the service to the user of the vehicle based on the service information shared between the on-board equipment and the communication equipment.

In the above service management system, the service information may include restriction information for restricting use of the service by the user.

With the above configuration, it is possible to restrict the use of the service by the user of the vehicle.

In the above service management system, the restriction information may include the number of users that use the service.

With the above configuration, it is possible to restrict the number of users that can use the service.

In the above service management system, the restriction information may include at least one of the number of times, a duration, and a time range of the use of the service.

In the service management system, the service management unit may execute exclusive control, when the service management unit reads from the storage unit the service information associated with one user ID in response to requests from the communication equipment possessed by a plurality of the users.

With the above configuration, it is possible to restrict the number of users that can simultaneously use the service information associated with one user ID.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram schematically illustrating a configuration of a service management system according to an embodiment;

FIG. 2 is a schematic view illustrating an example of data stored in data tables;

FIG. 3 is a schematic view illustrating an example of associations between various kinds of information related to a user ID;

FIG. 4 is a schematic view illustrating an example of classification of services to be provided to users of vehicles;

FIG. 5 is a schematic view illustrating an example of data in license information;

FIG. 6 is a schematic view illustrating an example of associations between various kinds of information related to user IDs;

FIG. 7 is a schematic view illustrating a procedure to initially register various kinds of information associated with the license information;

FIG. 8 is a sequence chart illustrating a service management procedure performed by the service management system according to the embodiment;

FIG. 9A is a schematic view illustrating an example of ID management performed by the service management system according to the related art;

FIG. 9B is a schematic view illustrating an example of ID management performed by the service management system according to the embodiment; and

FIG. 10 is a schematic view illustrating an example of ID management performed by the service management system according to the embodiment.

### DETAILED DESCRIPTION OF EMBODIMENTS

Hereinafter, an embodiment of a service management system will be described with reference to the drawings.

The service management system according to the embodiment is a system for managing service information (license information) required when a user of a vehicle uses a service provided by an application using the vehicle. The system is configured such that a mobile information terminal (communication equipment) possessed by the user of the vehicle can communicate with the vehicle. A vehicle ID and a user ID are transmitted to a data center that manages a number of pieces of vehicle information. The mobile information terminal obtains the vehicle ID through communication with the vehicle. The user ID is identification information of the user possessing the mobile information terminal. When receiving the vehicle ID and the user ID from the mobile information terminal, the data center reads the license information associated with the vehicle ID and the user ID from a storage unit. The data center returns the read license information to the mobile information terminal that is a sending source. Thus, the use of the service using the vehicle at the mobile information terminal is managed.

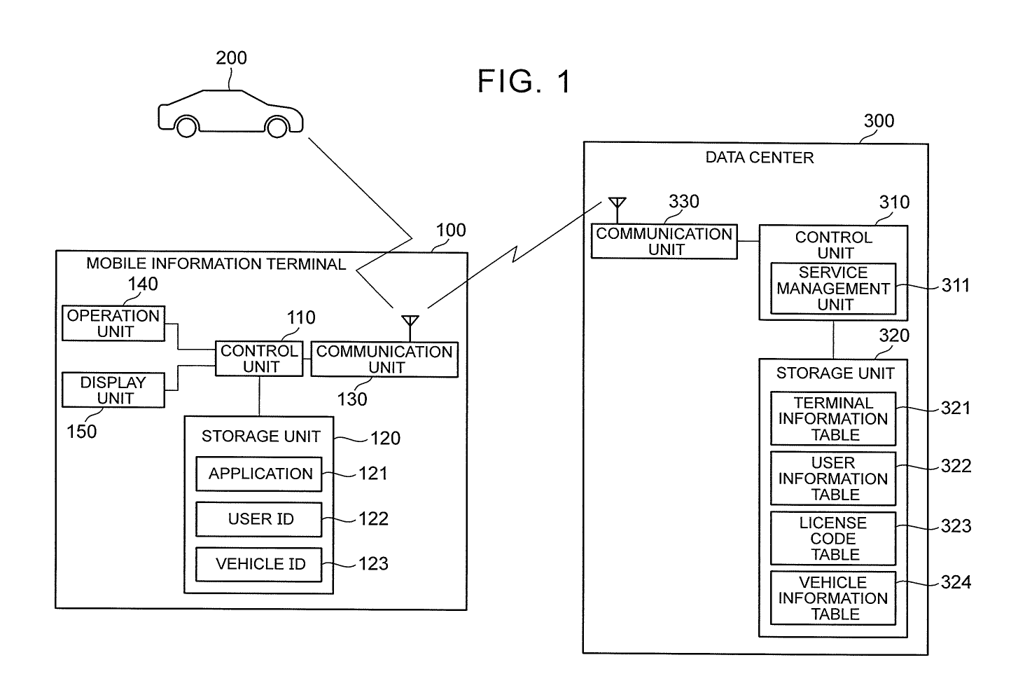

Specifically, the mobile information terminal 100 includes a control unit 110, a storage unit 120, a communication unit 130, an operation unit 140, and a display unit 150, as shown in FIG. 1.

The control unit 110 controls the operation of the mobile information terminal 100 as a whole, and can run various applications 121 including an application using the vehicle.

The storage unit 120 stores a user ID 122 that is identification information of the user possessing the mobile information terminal 100, in addition to the various applications 121. An email address of the mobile information terminal 100 is used as the user ID 122, for example.

The communication unit 130 and the vehicle 200 carry out wireless communications with Bluetooth (registered trademark) or the like. Through the wireless communications established between the communication unit 130 and the vehicle 200, the communication unit 130 receives, from the vehicle 200, a vehicle ID 123 that is identification information of the vehicle 200, and stores the vehicle ID 123 in the storage unit 120.

The operation unit 140 and the display unit 150 function as a user interface through which the user operates the mobile information terminal 100. The operation unit 140 includes an operation switch such as a push button, and outputs an operation signal to the control unit 110. When the display unit 150 is a touch-panel display, the display unit 150 also functions as the operation unit 140.

A data center 300 includes a control unit 310, a storage unit 320, and a communication unit 330.

The control unit 310 controls the operation of the data center 300 as a whole, and functions as a service management unit 311 that manages the use of application 121 using the vehicle at the mobile information terminal 100 based on a request by the mobile information terminal 100.

The storage unit 320 stores various kinds of data that are used by the service management unit 311 to manage the use of the application 121. The various kinds of data include a terminal information table 321, a user information table 322, a license code table 323, and a vehicle information table 324, for example.

When receiving the user ID 122 and the vehicle ID 123 from the mobile information terminal 100 through the communication unit 130, the service management unit 311 refers to the tables 321 to 324 stored in the storage unit 320 to extract the license information required when the user uses the application 121 using the vehicle 200, based on the user ID 122 and the vehicle ID 123. The service management unit 311 transmits, through the communication unit 330, the extracted license information to the mobile information terminal 100 that is a sending source of the user ID 122 and the vehicle ID 123. Thus, the use of the application 121 at the mobile information terminal 100 is managed based on the license information.

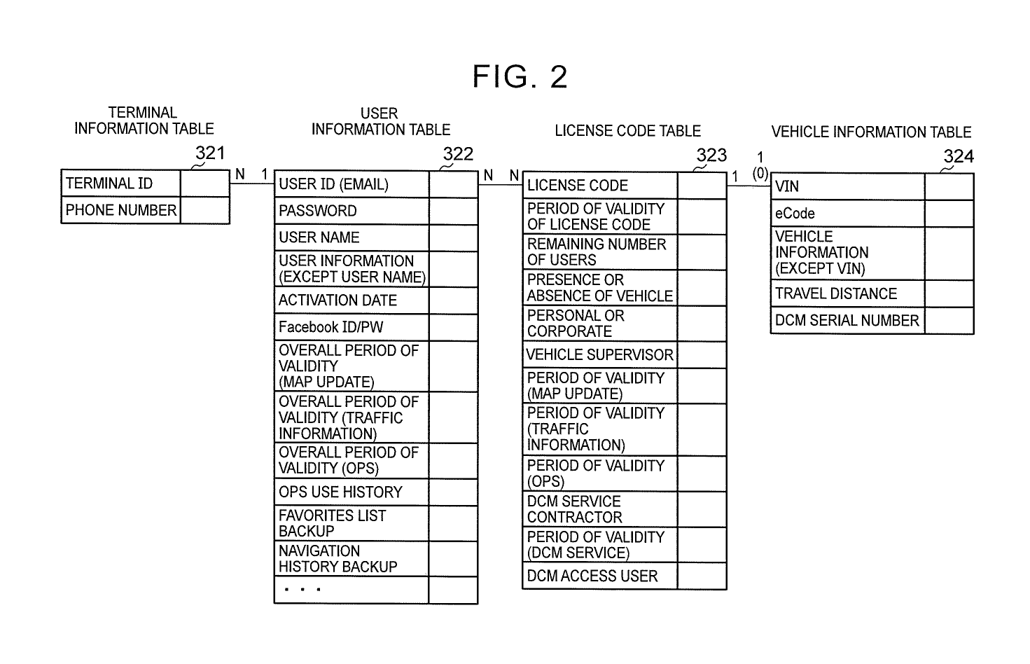

More specifically, as shown in FIG. 2, the terminal information table 321 contains a telephone number or the like of the mobile information terminal 100, with a terminal ID serving as a key. The terminal ID is individual information of the mobile information terminal 100.

The user information table 322 contains a password for authentication of the user ID 122, user information such as a user name, personal information of the user such as service use history information, a period of validity of a navigation service based on the user ID 122, and so forth, with the user ID 122 serving as a key. The user ID 122 is received by the data center 300 from the mobile information terminal 100.

The license code table 323 contains a period of validity of a license, license restriction information such as the number of users that can use the license and a period of validity of the navigation service based on the license code, license contractor information, information on a supervisor of the licensed vehicle, and so forth, with the license code serving as a key. The license code functions as an identification number of the license information.

The vehicle information table 324 contains travel history information such as a travel distance of the vehicle and on-board equipment information such as a serial number of a data communication module (DCM) installed in the vehicle, and so forth, with a vehicle identification number (VIN) serving as a key.

The terminal information table 321 and the user information table 322 are associated with each other, based on the terminal ID and the user ID 122 that serve as the keys for the terminal information table 321 and the user information table 322. A plurality of terminal IDs can be associated with one user ID. That is, when the user possesses the plurality of mobile information terminals 100, the terminal information tables 321 that differ depending on the types of the mobile information terminals 100 are associated with the common user information table 322.

The user information table 322 and the license code table 323 are associated with each other based on the user ID 122 and the license code that serve as the keys for the user information table 322 and the license code table 323, respectively. The plurality of license codes can be associated with one user ID. That is, when the user has licenses for the plurality of vehicles, the license code tables 323 that differ between the vehicles are associated with the common user information table 322. The plurality of user IDs 122 can be associated with one license code. That is, when the plurality of users has the license for one vehicle, the user information tables 322 that differ between the users are associated with the common license code table 323.

The license code table 323 and the vehicle information table 324 are associated with each other based on the license code and the VIN that serve as the keys for the license code table 323 and the vehicle information table 324, respectively. One VIN can be associated with one license code. That is, the license information for one vehicle is common, and the license code table 323 and the vehicle information table 324 have a one-to-one correspondence.

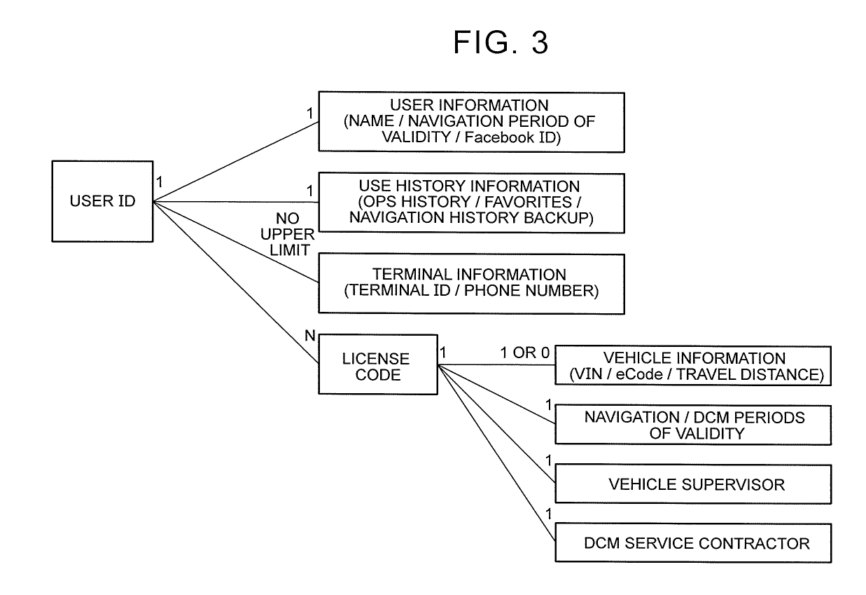

Thus, as shown in FIG. 3, the user information, the service use history information, the terminal information of the mobile information terminal 100, and the license code are associated with one user ID. In this case, there are one-to-one correspondences between the user ID and the user information and between the user ID and the service use history information. In contrast, the plurality of pieces of terminal information can be associated with one user ID, and there is no upper limit for the number of pieces of terminal information. Although the plurality of license codes can be associated with one user ID, there is an upper limit for the number of such license codes (for example, five).

The vehicle information, the periods of validity of the navigation service and DCM, the information on the supervisor of the licensed vehicle, the contractor information of the service using DCM are associated with one license code. In this case, there are one-to-one correspondences between the license code and each of the above information.

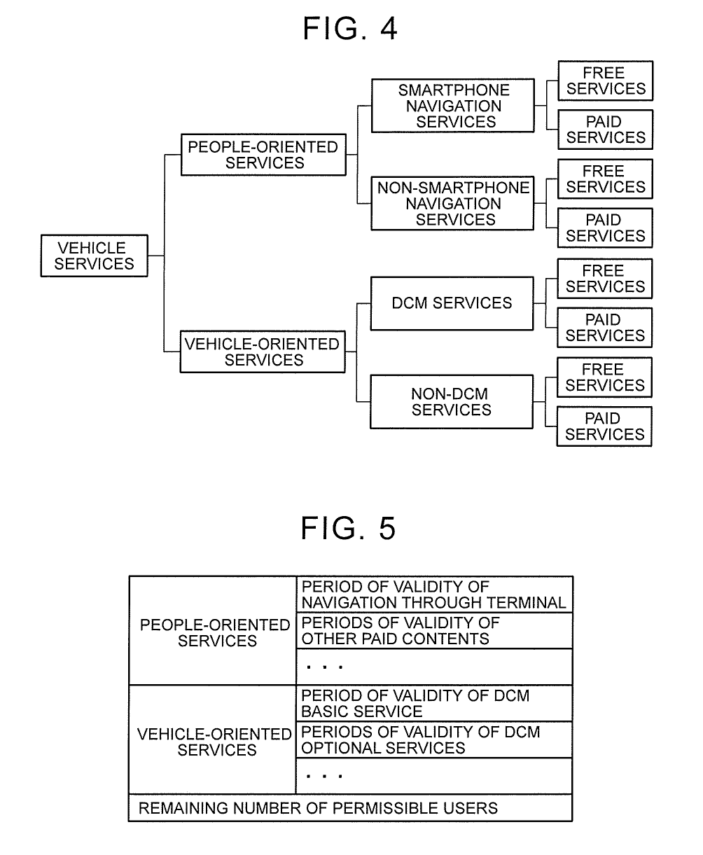

As shown in FIG. 4, the services to be provided to the vehicle users are classified into people-oriented services based on the users and vehicle-oriented services based on the vehicles. The people-oriented services are classified into navigation services using the mobile information terminals 100 of the users and other services. The vehicle-oriented services are classified into services using the DCM installed in the vehicle and services without using the DCM. The classified services include free services and paid services.

As shown in FIG. 5, the license information includes the license information for the people-oriented services and the license information for the vehicle-oriented services, in addition to the number of users that can use the license, which has been described above. In the example shown in FIG. 5, the license information for the people-oriented services includes the period of validity of the navigation service using the mobile information terminal 100 and the periods of validity of other paid contents. In the example, the license information for the vehicle-oriented services includes the period of validity of the basic service using the DCM and the periods of validity of optional services using the DCM.

Next, the setting of the license information of the application when the user possessing the mobile information terminals 100 uses the vehicle 200 will be described based on specific examples.

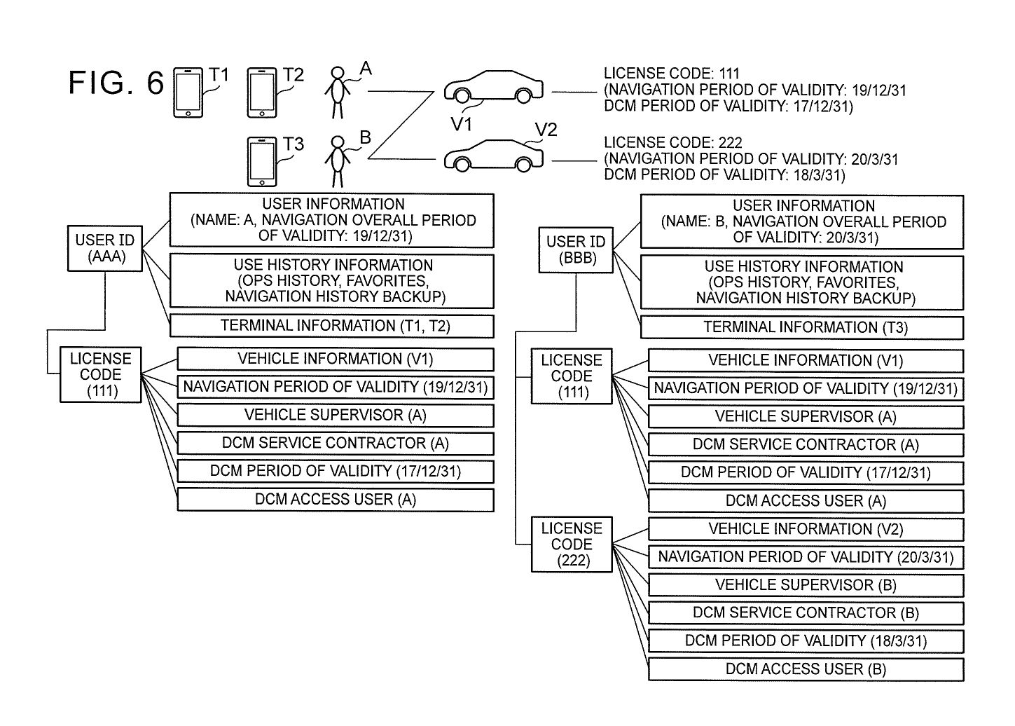

The example shown in FIG. 6 involves two users (user A, user B) and two vehicles (vehicle V1, vehicle V2). In the example, the user A possesses two mobile information terminals 100 (terminal T1, terminal T2) and the user B possesses one mobile information terminal 100 (terminal T3). The user A is registered as a user of the vehicle V1, while the user B is registered as a user of both the vehicle V1 and the vehicle V2.

In this case, the user ID 122 (AAA) corresponding to the user A is associated with the user information and the service use history information of the user A, and is also associated with the terminal information of the terminals T1, T2 possessed by the user A. The user ID 122 (AAA) is associated with the license code (111) corresponding to the vehicle V1. The license code (111) is associated with the vehicle information and the license information of the vehicle V1.

The user ID 122 (BBB) corresponding to the user B is associated with the user information and the service use history information of the user B, and is also associated with the terminal information of the terminal T3 possessed by the user B.

The user ID 122 (BBB) is associated with the license code (111) corresponding to the vehicle V1 and the license code (222) corresponding to the vehicle V2. The license code (111) is associated with the vehicle information and the license information of the vehicle V1. The license code (222) is associated with the vehicle information and the license information of the vehicle V2.

When the user A uses the vehicle V1, the license code (111) is applied, which is associated with the user ID 122 (AAA) corresponding to the user A and is assigned to the vehicle V1. The periods of validity (the period of validity of the navigation service using the mobile information terminal 100 and the period of validity of the service using the DCM) associated with the license code (111) are applied.

When the user B uses the vehicle V2, the license code (222) is applied, which is associated with the user ID 122 (BBB) corresponding to the user B and is assigned to the vehicle V2. The periods of validity (the period of validity of the navigation service using the mobile information terminal 100 and the period of validity of the service using the DCM) associated with the license code (222) are applied.

Next, the procedure to initially register various kinds of information associated with the license information will be described.

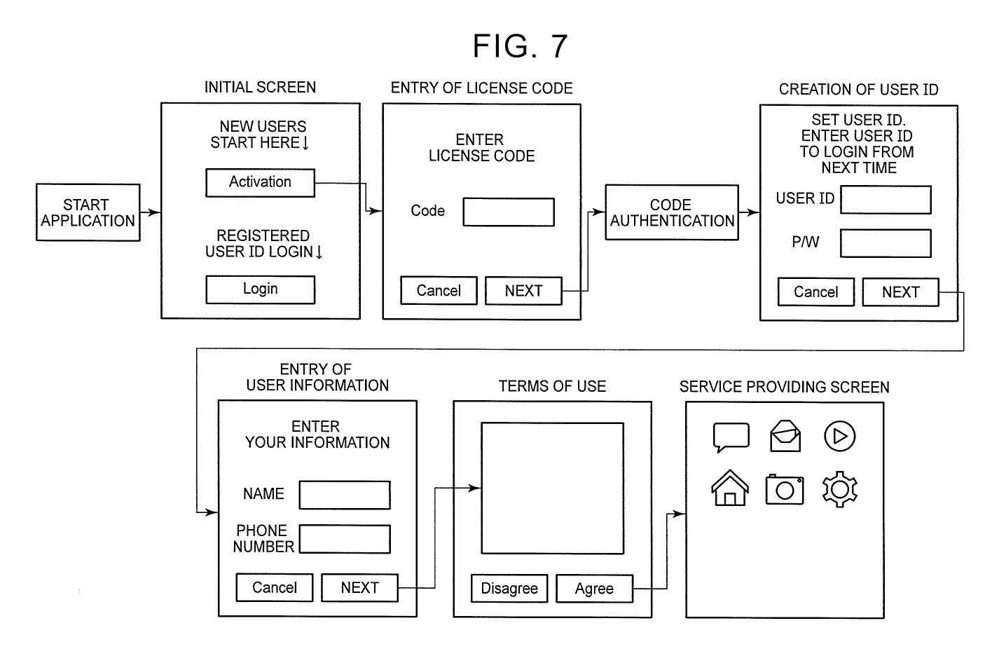

As shown in FIG. 7, at the time of initial registration of various kinds of information, the operation unit 140 of the mobile information terminal 100 is operated to start the application 121.

Then, an initial screen related to the application 121 is displayed on the display unit 150 of the mobile information terminal 100.

When the initial registration of the user ID is selected on the initial screen, a screen for inputting the license code is displayed on the display unit 150.

When the license code is subsequently input through the operation unit 140, authentication for the license code is conducted. The code authentication is conducted to check whether there is a license code identical to the input license code, among the license codes registered in the license code table 323. When the input license code is authenticated, a user ID creation screen is displayed on the display unit 150.

When the user ID and the password are input on the user ID creation screen through the operation unit 140, a user information input screen is displayed on the display unit 150.

When the user name and the telephone number of the mobile information terminal 100 are input on the user information input screen through the operation unit 140, a screen showing terms of use of the application 121 is displayed on the display unit 150.

When input indicating agreement is made on the screen showing the terms of use through the operation unit 140, a screen for providing services using the application 121 is displayed on the display unit 150. In this case, the screen displays the services of which use has been permitted based on the license information, but does not display the services of which use has been prohibited based on the license information. That is, the use of the services using the application 121 is managed based on the license information.

Next, the service management procedure performed by the service management system according to the embodiment will be described.

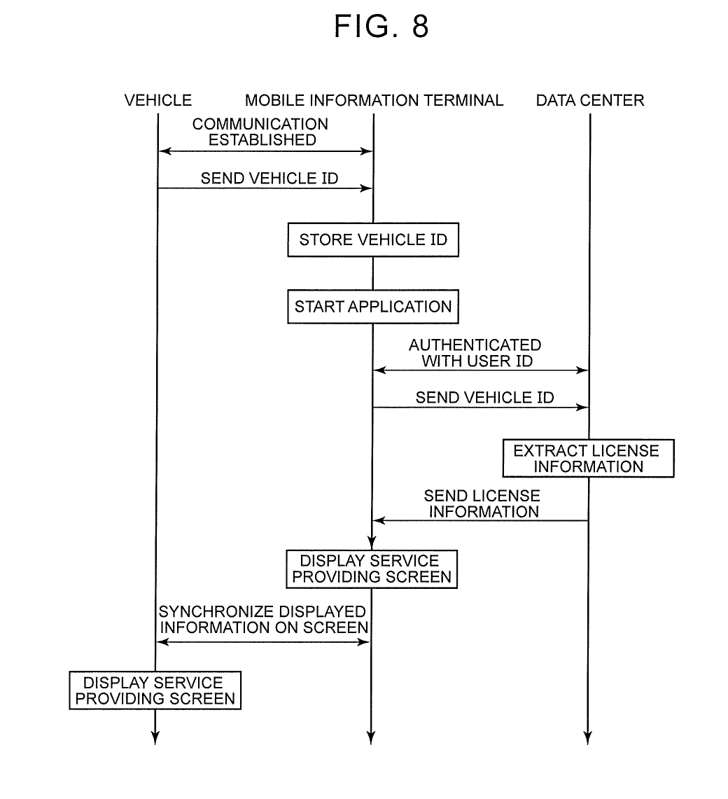

As shown in FIG. 8, in the embodiment, it is assumed that when the wireless communication is established between the vehicle 200 and the mobile information terminal 100, the vehicle ID 123 of the vehicle 200 is transmitted from the vehicle 200 to the mobile information terminal 100. Then, the mobile information terminal 100 stores the vehicle ID 123 received from the vehicle 200 into the storage unit 120.

When the service is provided to the vehicle user, the application 121 installed in the mobile information terminal 100 possessed by the user is started first. Upon the start of the application 121, a screen for inputting the user ID 122 is displayed on the display unit 150 of the mobile information terminal 100.

When the user ID 122 is input through the operation unit 140 of the mobile information terminal 100, the input user ID 122 is transmitted from the mobile information terminal 100 to the data center 300. At this time, the data center 300 conducts authentication of the user ID 122 input through the mobile information terminal 100. When the user ID 122 is authenticated by the data center 300, the mobile information terminal 100 reads the vehicle ID 123 stored in the storage unit 120 and transmits the vehicle ID 123 to the data center 300.

Then, based on the user ID 122 and the vehicle ID 123 transmitted through the mobile information terminal 100, the data center 300 refers to the user information table 322, the license code table 323, and the vehicle information table 324 to extract the license information corresponding to the combination of the user ID 122 and the vehicle ID 123 from the license code table 323.

More specifically, the data center 300 refers to the user information table 322 and the license code table 323 to extract one or more license codes associated with the user ID 122. When there is only one license code associated with the user ID 122, the data center 300 extracts the license information corresponding to the combination of the user ID 122 and the vehicle ID 123 from the license code table 323, based on the license code. In contrast, when there is a plurality of license codes associated with the user ID 122, the data center 300 selects the license code associated with the vehicle ID 123 from the license codes. Based on the selected license code, the data center 300 extracts the license information corresponding to the combination of the user ID 122 and the vehicle ID 123 from the license code table 323. The data center 300 then transmits the license information extracted from the license code table 323 to the mobile information terminal 100.

The mobile information terminal 100 then displays on the display unit 150 the screen for providing services using the application 121, of which use is restricted based on the license information received from the data center 300. At this time, the mobile information terminal 100 synchronizes the displayed information with the on-board equipment installed in the vehicle 200. Thus, the on-board equipment installed in the vehicle 200 displays, as is the mobile information terminal 100, the screen for providing the services using the application 121, of which use is restricted based on the license information described above.

Next, the operation of the service management system according to the embodiment will be described.

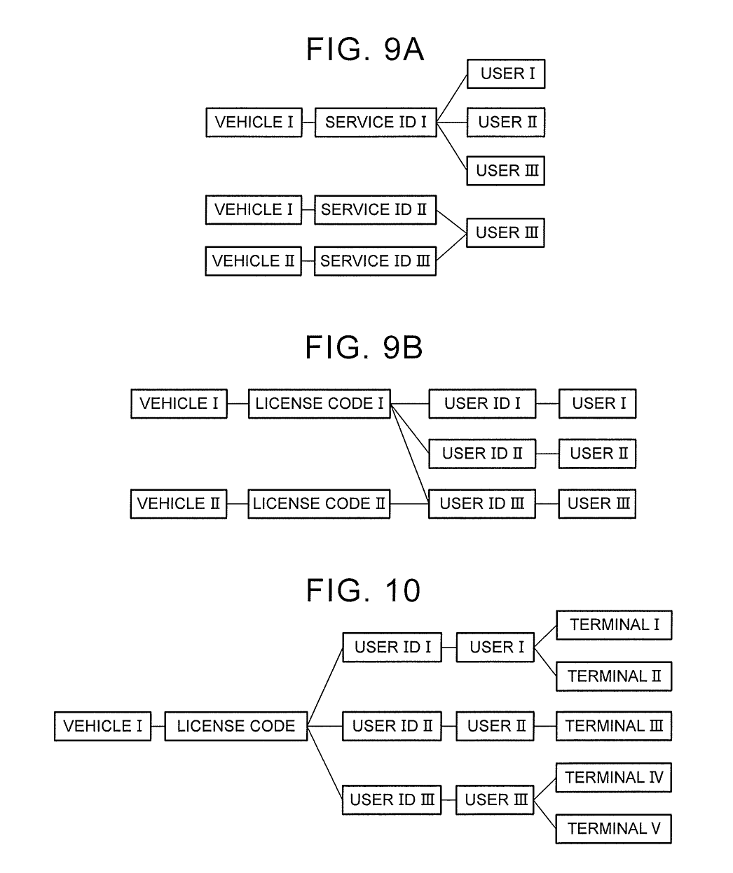

In a system according to the related art shown in FIG. 9A, one service ID is assigned to each vehicle 200 and one or more users are associated with the service ID, regarding the use of the services by the users of the vehicle 200.

In the system, when the plurality of users uses the service using one vehicle 200, one service ID is referred to by the plurality of users. This makes it difficult to know the service use history of each user.

Also in the system, when one user has a plurality of vehicles, the individual service IDs for the corresponding vehicles are associated with the user. Therefore, the user has to use different service IDs depending on the vehicle, which decreases convenience for the user. In addition, the service use history of the user is managed based on the vehicle, which also makes it difficult to know the service use history of each user.

In the embodiment, one license code is associated with one vehicle 200, and one or more user IDs are associated with each license code, as shown in FIG. 9B.

In the system, even when using the services using the plurality of vehicles 200, the user uses their user ID 122 so that the license code are read, thus benefiting from improved convenience. Furthermore, it is possible to know the service use history of each user. In addition, it is possible to restrict the available services depending on the user so as to manage the available services of each user.

As shown in FIG. 10, when the user possesses the plurality of mobile information terminals 100, the plurality of mobile information terminals 100 is associated with one user ID 122. In this case, requests to read the license code based on one user ID 122 may be made simultaneously by the plurality of mobile information terminals 100.

In this regard, the service management unit 311 of the data center 300 according to the embodiment executes exclusive control when reading the license code based on the user ID 122. Therefore, the number of license codes readable based on one user ID 122 is limited to one. Thus, it is possible to appropriately restrict the number of users that can use the services based on the license information.

According to the embodiment described above, the following effects can be obtained.

(1) When the user of the vehicle 200 uses the services, content of the services to be provided to the user varies based on the license information associated with both the vehicle ID 123 and the user ID 122. The license information differs depending on the combination of the user and the vehicle. Thus, it is possible to manage the services to be provided to each user of the vehicle 200.

(2) The services to be provided to the user of the vehicle 200 include the free services and the paid services. Thus, it is possible to expand the content of the services to be provided to the user of the vehicle 200.

(3) The license information includes the periods of validity and the contractor information of the services to be provided to the user of the vehicle 200. Thus, it is possible to manage the content of the services to be provided to the user of the vehicle 200 in accordance with the content of contract of each service.

(4) The license information includes the information on the supervisor of the vehicle 200 for which the services are provided. Thus, it is possible to manage the content of the services to be provided to the user of the vehicle 200 depending on whether the user of the vehicle 200 is the supervisor of the vehicle 200.

(5) The services to be provided to the user of the vehicle 200 include services available both through the on-board equipment installed in the vehicle 200 and through the mobile information terminal 100 that communicates with the vehicle 200. Thus, it is possible to provide the services to the user of the vehicle 200 based on the license information shared between the on-board equipment and the mobile information terminal 100.

(6) The license information includes the number of users that can use the services as the license restriction information for restricting the use of the services by the users. Thus, it is possible to restrict the number of users that can use the services in accordance with the license information.

(7) The service management unit 311 executes the exclusive control when reading the license information associated with one user ID 122 from the storage unit 320 in response to the requests from the mobile information terminals 100 possessed by the plurality of users. Thus, it is possible to restrict the number of users that can use the license information associated with one user ID 122.

The embodiment may be carried out in the following modes.

In the embodiment, the service management unit 311 executes the exclusive control when reading, from the storage unit 320, the license information associated with one user ID 122 in response to the requests from the mobile information terminals 100 possessed by the plurality of users. However, the number of mobile information terminals 100 associated with one user ID 122 may be limited to only one.

In the embodiment, the license information includes the number of users that can use the services as the restriction information for restricting the use of the services by the users. However, the restriction information for restricting the use of the services by the users may also include the number of times, a duration, and a time range of the use of the services.

In the embodiment, the services to be provided to the user of the vehicle 200 include the services available through both the on-board equipment installed in the vehicle 200 and the mobile information terminal 100 that communicates with the vehicle 200. However, the services to be provided to the user of the vehicle 200 may be services available through either one of the on-board equipment and the mobile information terminal 100.

In the embodiment, the license information includes the information on the supervisor of the vehicle for which the services are provided. However, the license information need not include the information on the supervisor of the vehicle 200. That is, the content of the services to be provided to each user of the vehicle 200 may be managed regardless of whether the user of the vehicle 200 is the supervisor of the vehicle 200.

In the embodiment, the license information includes the periods of validity and the contractor information of the services to be provided to the user of the vehicle 200. However, the license information need not include the information on the content of contract of each service. That is, the content of the services to be provided to each user of the vehicle may be managed without taking into account the content of contract of each service.

In the embodiment, the services to be provided to the user of the vehicle 200 include the free services and the paid services. However, the services to be provided to the user of the vehicle 200 may include either the free services or the paid services.

In the embodiment, the data center 300 refers to the user information table 322 and the license code table 323 to extract the license code associated with the user ID 122. When there is the plurality of license codes associated with the user ID 122, the data center 300 selects the license code associated with the vehicle ID 123 from the license codes. However, the data center 300 may refer to the vehicle information table 324 to extract the license code associated with the vehicle ID 123. The data center 300 may read the license information corresponding to the extracted license code, on condition that the license code is associated with the user ID 122.

In the embodiment, the mobile information terminal 100 that communicates with the vehicle 200 requests the data center 300 to provide the license information. However, the on-board equipment may directly request the data center 300 to provide the license information, as long as the on-board equipment has a communication function like a navigation apparatus installed in the vehicle 200.

What is claimed is:

1. A service management system comprising:
a storage unit that stores service information associated with a vehicle ID assigned to each vehicle and a user ID assigned to each user of the vehicle, the service information including content of a service to be provided to the user of the vehicle; and
a service management unit configured to read from the storage unit the service information associated with both the vehicle ID assigned to the vehicle and the user ID assigned to the user and manage the content of the service to be provided to the user of the vehicle when the user of the vehicle uses the service.

2. The service management system according to claim 1, wherein the service includes a free service and a paid service.

3. The service management system according to claim 1, wherein the service information includes a period of validity of the service and contractor information of the service.

4. The service management system according to claim 1, wherein the service information includes information on a supervisor of the vehicle.

5. The service management system according to claim 1, wherein the service to be provided to the user of the vehicle includes a service available both through on-board equipment installed in the vehicle and through communication equipment that communicates with the vehicle.

6. The service management system according to claim 1, wherein the service information includes restriction information for restricting use of the service by the user.

7. The service management system according to claim 6, wherein the restriction information includes the number of users that use the service.

8. The service management system according to claim 6, wherein the restriction information includes at least one of the number of times, a duration, and a time range of the use of the service.

9. The service management system according to claim 1, wherein the service management unit executes exclusive control, when the service management unit reads from the storage unit the service information associated with one user ID in response to requests from communication equipment possessed by a plurality of the users.

10. A non-transitory computer-readable medium storing a program causing a computer, which includes a storage unit in which service information including content of a service to be provided to a user of a vehicle, a vehicle ID assigned to each vehicle, and a user ID assigned to each user of the vehicle are associated with each other, to execute a process, when the user of the vehicle uses the service, the process comprising:
reading from the storage unit the service information associated with both the vehicle ID and the user ID; and
managing the content of the service to be provided to the user of the vehicle.

11. A service management method for managing service information including content of a service to be provided to a user of a vehicle, the method comprising:
associating a vehicle ID assigned to each vehicle with service information, and associating a user ID assigned to each user of the vehicle with the service information; and
managing the content of the service by providing the user of the vehicle with the service information associated with both the vehicle ID assigned to the vehicle and the user ID assigned to the user when the user of the vehicle uses the service.
